(19) United States
(12) Patent Application Publication
(10) Pub. No.: US 2008/0014053 A1
(43) Pub. Date: Jan. 17, 2008

(54) Device Of Securing An Object

(76) Inventor: Stephen Martin Healy, Port Arlington (AU)

Correspondence Address: QUINE INTELLECTUAL PROPERTY LAW GROUP, P.C., P O BOX 458, ALAMEDA, CA, 94501, US

(21) Appl. No.: 11/791,703

(22) PCT Filed: Nov. 25, 2005
(86) PCT No.: PCT/AU05/01788

§ 371 Date: May 25, 2007

(30) Foreign Application Priority Data
Nov. 25, 2004 (AU) 2004906757

(51) Int. Cl. B65G 67/60

(52) U.S. Cl. 414/138.8

(57) ABSTRACT

A device (1) for locking an object (16) to a transportation vehicle (51) comprising a receiver (12) securable to the transportation vehicle for receiving a portion (14) of the object, a plate (30) deflectable by the portion of the object to enable release of a locking pin (38), the locking pin locking the portion of the object to the receiver.

### FIELD OF THE INVENTION

This invention relates to a device for securing or locking an object to a transportation vehicle. More particularly this invention relates to a device for locking a portion of an object, such as a vehicle, vessel or equipment to a trailer to enable transportation of the object.

### BACKGROUND TO THE INVENTION

In order to load an object, such as a vessel, and in particular a boat, onto a transportation vehicle, such as a trailer, the trailer is manoeuvred on a ramp at the water's edge and the boat is then hauled onto the trailer using a winch. Generally two or more people are needed in order to securely place the boat on the trailer, with one person operating the winch and another person in the water to guide the boat along various rollers or receiving devices placed on the trailer. This operation is cumbersome and requires excessive labour, that is, more than one person in order to secure the boat to the trailer. Furthermore the boat ramp is generally slippery and there is potential for a person, trying to load the boat onto the trailer, to sustain injury due to the slippery surface of the ramp.

The present invention seeks to overcome one or more of the above disadvantages by providing a device for locking an object to a transportation vehicle that can be operated by one person and can be operated by a person standing in or adjacent the object.

### SUMMARY OF THE INVENTION

According to a first aspect of the invention there is provided a device for locking an object to a transportation vehicle comprising:

a receiver securable to the transportation vehicle for receiving a portion of the object; and

a plate deflectable by the portion of the object to enable release of a locking pin, the locking pin locking the portion of the object to the receiver.

The device may further comprise an aperture located in at least one wall of the receiver allowing passage of the locking pin.

The device preferably comprises a flange connected to the plate, such that in a first position of the plate, in which the portion of the object does not engage the plate, the flange partially covers the aperture to prevent the locking pin protruding through the aperture, and in a second position the portion of the object engages the plate such that the flange is clear of the aperture to enable the locking pin to protrude through the aperture and lock the portion of the object to the receiver.

Preferably the locking pin is actuated for movement through the aperture by resilient means. Preferably the locking pin resides within a housing and the resilient means also resides within the housing around the locking pin enabling extension and retraction of the locking pin.

Preferably the device further comprises a further resilient means attached to the plate enabling the plate to deflect and return to a state prior to deflection by the portion of the object. The plate preferably abuts against an internal wall of the receiver in a fully deflected state whereupon the flange clears the aperture to enable the locking pin to lock the portion of the object to the receiver.

Preferably the portion of the object has an opening through which the locking pin protrudes in order to lock the portion to the receiver. Preferably the portion of the object is substantially U-shaped having a pair of legs, each leg in the pair of legs connected to the object. The portion of the object may be a bow eye and the locking pin may protrude through the pair of legs of the bow eye.

The object may be any one of a vehicle, vessel, container, plant and equipment or article requiring transportation to another location.

The object is preferably a water vessel, such as a boat, yacht or jet ski, and the portion of the vessel may be a bow eye located at the bow of the boat, yacht or jet ski. In order to secure the bow eye to the receiver, the locking pin may extend between the pair of legs of the bow eye. The device may be affixed to a transportation vehicle, preferably a trailer. This enables an operator of the vessel to steer the vessel onto the trailer until the bow eye is secured in the receiver portion. A pair of guide fins may be adjacent to an opening of the receiver to enable the portion of the object to be guided into the receiver and subsequently contact the plate, preferably a pressure plate.

Preferably, in order to lock the water vessel to the transportation vehicle an operator aboard the water vessel can steer the water vessel onto guide rollers on the transportation vehicle and thereafter steer the bow eye of the water vessel through the guide fins until the plate is deflected to allow the locking pin to extend through the aperture.

According to a second aspect of the invention there is provided a device for locking an object to a transportation vehicle comprising:

receiving means securable to the transportation vehicle for receiving a portion of the object;

a plate deflectable by the portion of the object as the portion of the object extends through an opening of the receiver means; and

a locking pin that is released upon the plate deflecting a predetermined distance to lock the portion of the object to the receiver.

According to a third aspect of the invention there is provided a transportation vehicle having the locking device according to either of the first or second aspects of the invention.

### BRIEF DESCRIPTION OF THE DRAWINGS

A preferred embodiment of the invention will hereinafter be described, by way of example only, with reference to the drawings wherein:

FIG. 1(A) is a plan view of the locking device;

FIG. 1(B) is a front view of the locking device;

FIG. 1(C) is a side of the device showing a portion of an object in a locked position;

FIG. 2 is a sectional view taken on line C-C of FIGS. 1(A) and 1(B) with the object portion not secured in the locking device;

FIG. 3 is a sectional view taken on line B-B of FIGS. 1(A) and 1(B) with the object portion not secured in the locking device;

FIG. 4 is a reverse sectional view taken on line C-C of FIGS. 1(A) and 1(B) with the object portion secured in the locking device;

FIG. 5 is a sectional view taken on line B-B of FIGS. 1(A) and 1(B) with the object portion secured in the locking device; and

FIG. 6 is a side view showing the object secured to a transportation vehicle and towed by a vehicle.

### DETAILED DESCRIPTION OF THE PREFERRED EMBODIMENTS

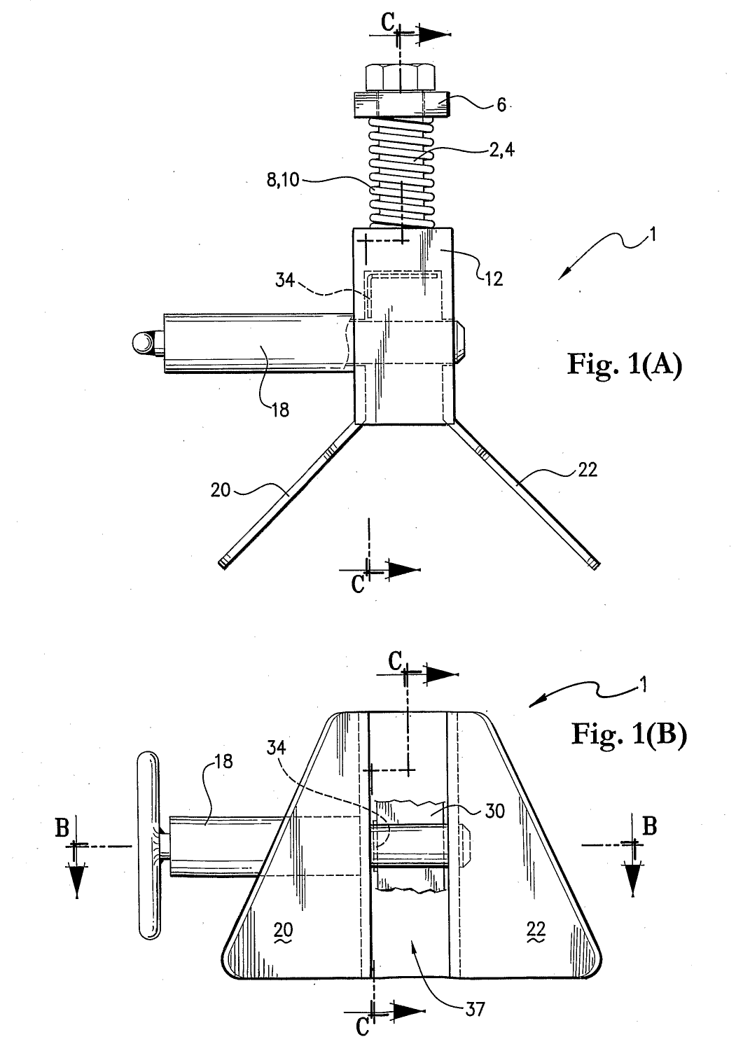

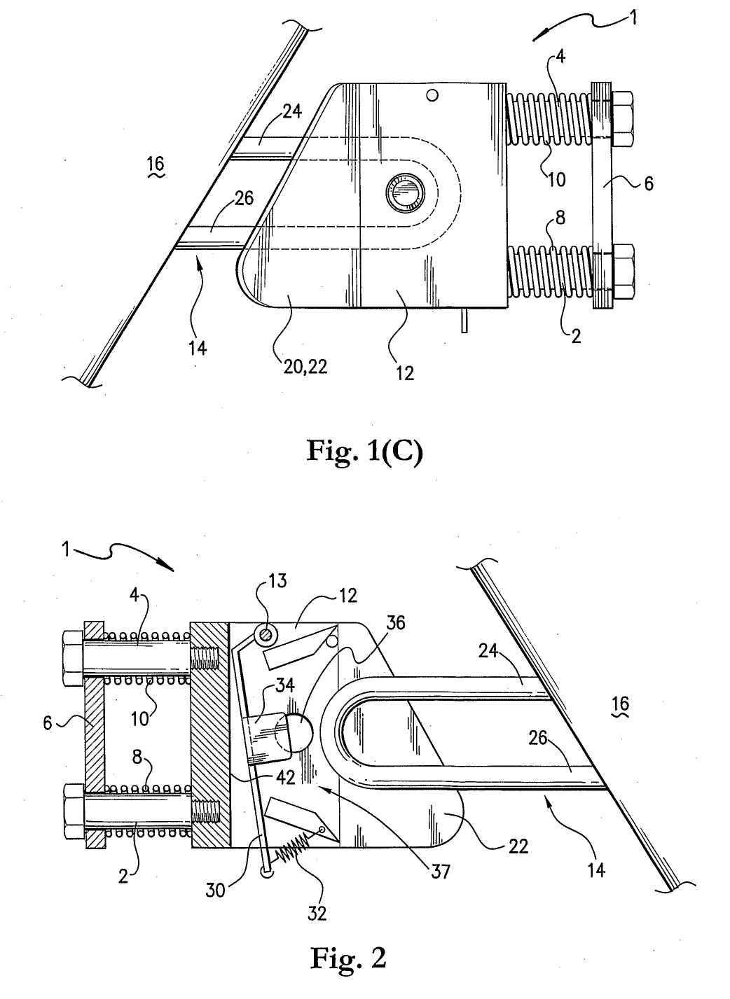

With reference to FIGS. 1A, 1B and 1C there is respectively shown a plan view, front view and side view of a device 1 for securing a portion of an object, such as a boat, to a transportation vehicle, such as a trailer. A pair of bolts 2 and 4 are mounted within a bracket 6 which bracket 6 attaches to the trailer. Each bolt 2 and 4 has compression means in the form of a helical compression spring (or alternatively a buffer spring) 8 and 10 respectively mounted on the shafts of the bolts. A receiver or receiver body 12 is adapted to receive a bow eye 14 which is attached to the bow of boat 16 and is secured in place via a locking pin housed in locking pin housing 18. A pair of guide fins 20 and 22 are splayed outwardly from a central axis of the receiver body 12 in order to act as a guide for the bow eye 14 as it moves into the receiver body 12. Both the locking pin housing 18 and the bolts 2 and 4 may form part of the receiver body 12. The locking pin housing 18 is generally perpendicular with respect to the central axis of the receiver body 12 and is therefore also perpendicular to the plane in which the bow eye has both sections 24 and 26 located.

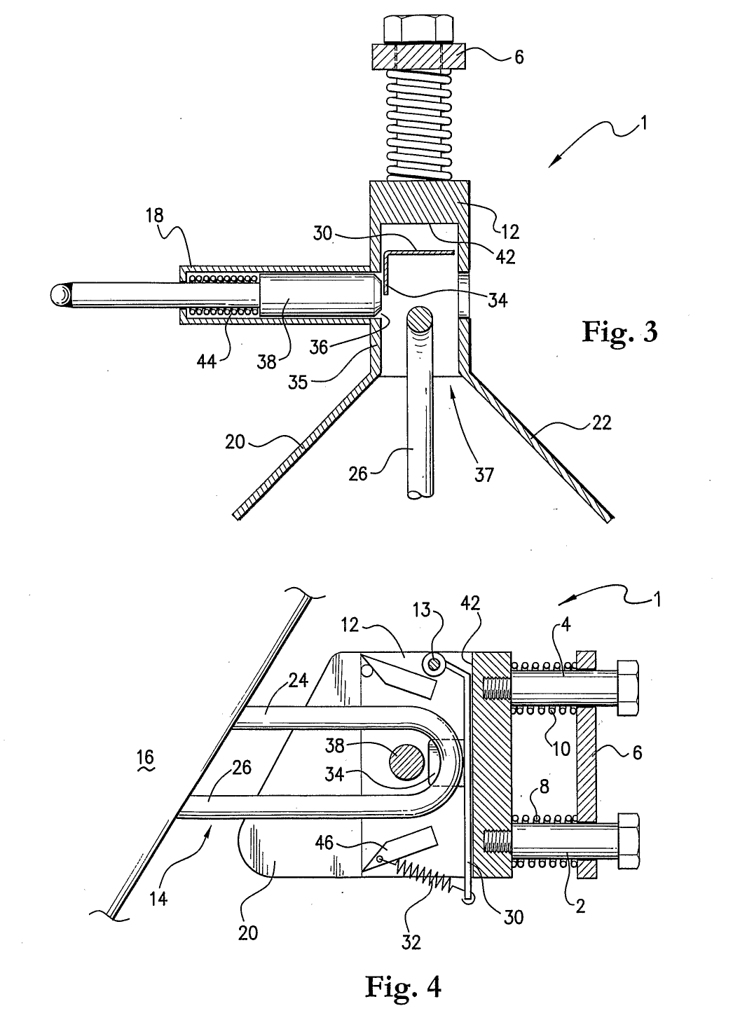

With reference to FIGS. 2 and 3 there is shown various sectional views disclosing internal portions of the receiver body 12. Specifically a pressure plate 30 is adapted to vary its position via spring 32 such that in one position a flange 34 connected to the pressure plate 30 partially covers an aperture 36, located in a wall 35 of the receiver 12, preventing a locking pin 38, housed within the locking pin housing 18, from protruding therethrough and a second position in which the flange 34 leaves the aperture completely free of obstructions so that the locking pin 38 can move through the interior of the receiver body 12. The plate 30 is hinged at one end by connection point 13.

In FIG. 2 the movement of the boat and therefore bow eye 14 into the opening 40 of the receiver body 12 eventually comes into contact with the pressure plate. Continued forward movement of the bow eye 14 forces the pressure plate 30 against wall 42 within the receiver body 12 as shown in a reverse view in FIG. 4. Such movement in turn forces the flange 34 to completely reveal the aperture 36. A spring 44 located around the circumference of locking pin 38 is in a compressed state when the flange 34 partially covers the opening 36 and prevents the locking pin 38 from moving into the interior of the receiver body 12. By moving the flange 34 away from the aperture 36 releases the locking pin 38 under extension of the spring 44 so that the locking pin 38 protrudes across the interior of the bow eye 14 and therefore prevents the bow eye 14 from being removed from the receiver body 12. This therefore secures the entire boat 16 to the trailer 51.

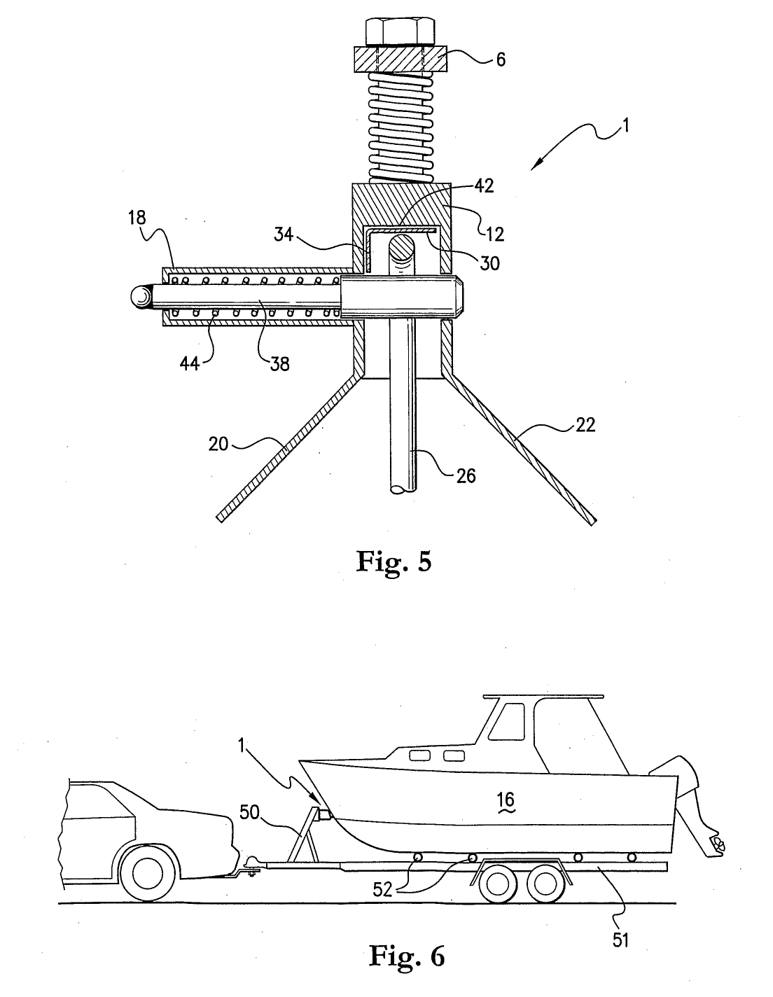

As seen from a reverse view in FIG. 4, that is a section taken through the line A-A of FIGS. 1A and B the sections 24 and 26 of bow eye 14 are in a position such that pressure plate 30 abuts the internal wall 42 of receiver body 12. The spring 32 is now fully extended which is connected to the pressure plate 30 and also to a further portion 46. The locking pin 38, shown normal to the plane of the FIG. 4, extends between the sections 24 and 26 of bow eye 14 such that it is locked in position. The receiver body 12 is adapted for movement towards and away from trailer bracket 6 via the compression springs 8, 10 that surround the bolts 2 and 4. The compression springs 8, 10 absorb forces as a result of any closing impact between the boat 16 and trailer 51 either as the boat 16 is being loaded onto the trailer 51 or during transportation. As seen clearly in FIG. 5 the flange 34 is clear of the aperture 36 allowing the locking pin 38 to traverse across the entire width of the receiver body 12 and thereby securing the bow eye 14.

A particular advantage of this arrangement is that an operator or driver of the boat 16 needs no further assistance and need not step out of the boat 16 in order to secure the boat 16 to the trailer 51. Once the trailer 51 is in position in the water, the driver can simply move the boat 16 towards the rear of the trailer 51 upon which the bow of the boat 16 is directed via the guide fins 20 and 22 through the opening 37 of the receiver body 12. Once the pressure plate 30 and flange 34 are clear of the aperture 36 then the locking pin 38 is able to project between the sections 24 and 26 of bow eye 14 to lock the bow eye 14 and therefore the boat 16 to the trailer 51.

Shown in FIG. 6 is an illustration of the boat 16 secured to the trailer 51 through the locking device 1 which is attached and permanently mounted to upright member 50 of the trailer 51 and is directed in a rearward fashion towards the boat 16 in order to receive the bow eye 14.

Typically the complete receiver body 12 without a casing would measure 100 mm in height, 150 mm in length and 150 mm in width. It is made from stainless steel but can be made from other suitable materials.

Thus in operation a driver of the boat 16 at the helm may steer the boat 16 onto guide rollers 52 on the trailer 51 which is set in position in shallow water at a boat ramp or boat launch. The driver then steers the boat 16 onto the trailer 51 where the bow eye 14 is guided through the fins 20 and 22 into the opening 37 of the receiver body 12. When the bow eye 14 contacts the pressure plate 30 and forces it back against an internal wall 42 this releases the locking pin 38 under the action of the compression spring 44 so that the locking pin 38 projects between sections 24 and 26 of bow eye 14 across the full width of the receiver body 12. Thus the bow eye 14 is locked in place and the boat 16 is secured to the trailer 51 ready for transport.

To release the boat 16 from the locking device 1, the operator simply pulls the locking pin 38 out clear of the aperture 36 which forces the plate 30 to return to its undeflected state, through compression of spring 32, allowing flange 34 to partially or fully cover aperture 36 to prevent passage therethrough of locking pin 38. The bow eye 14 is removed once the locking pin 38 is clear of aperture 36.

It is to be noted that the device is not only useful for watercraft transportation over land but for any particular object that needs to be loaded onto a trailer and is transported to another destination. Such objects can include, but are not limited to, any one of a vehicle, vessel, container, farming equipment or implements (such as ride-on mowers), and industrial plant and equipment. The device is also useful for disabled or aged persons who enjoy boating and thus makes it easier for loading and unloading from a trailer.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A device for locking an object to a transportation vehicle, the device comprising:
a receiver securable to the transportation vehicle for receiving a portion of the object; and
a plate deflectable by the portion of the object to enable release of a locking pin, the locking pin locking the portion of the object to the receiver.

2. A device according to claim 1 further comprising an aperture in at least one wall of the receiver allowing passage of the locking pin.

3. A device according to claim 2 further comprising a flange connected to the plate, such that in a first position of the plate, in which the portion of the object does not engage the plate, the flange partially covers the aperture to prevent the locking pin protruding through the aperture, and in a second position the portion of the object engages the plate such that the flange is clear of the aperture to enable the locking pin to protrude through the aperture and lock the portion of the object to the receiver.

4. A device according to claim 3 wherein the locking pin is actuated for movement through the aperture by resilient means.

5. A device according to claim 4 wherein the locking pin resides within a housing and the resilient means also resides within the housing around the locking pin enabling extension and retraction of the locking pin.

6. A device according to claim 4 further comprising a further resilient means attached to the plate enabling the plate to deflect and return to a state prior to deflection by the portion of the object.

7. A device according to claim 3 wherein the plate abuts against an internal wall of the receiver in a fully deflected state whereupon the flange clears the aperture to enable the locking pin to lock the portion of the object to the receiver.

8. A device according to claim 1 wherein the portion of the object has an opening through which the locking pin protrudes in order to lock the portion to the receiver.

9. A device according to claim 1 wherein the portion of the object is substantially U-shaped having a pair of legs, each leg in the pair of legs connected to the object.

10. A device according to claim 1 wherein the portion of the object is a bow eye and the locking pin protrudes through the pair of legs of the bow eye.

11. A device according to claim 1 wherein the object is selected from the group consisting of a vessel, vehicle, container, plant, and equipment.

12. A device according to claim 11 wherein the object is a water vessel, a boat, a yacht or a jet ski.

13. A device according to claim 1, wherein the transportation vehicle is a trailer.

14. A device according to claim 13 further comprising a pair of guide fins adjacent an opening of the receiver to enable the portion of the object to be guided into the receiver and subsequently contact the plate.

15. A device according to claim 14 wherein in order to lock the water vessel to the transportation vehicle an operator aboard the water vessel steers the water vessel onto guide rollers on the transportation vehicle and thereafter steers a bow eye of the water vessel through the guide fins until the plate is deflected to allow the locking pin to extend through the aperture.

16. A device for locking an object to a transportation vehicle comprising:
receiving means securable to the transportation vehicle for receiving a portion of the object;
a plate deflectable by the portion of the object as the portion of the object extends through an opening of the receiver means; and
a locking pin that is released upon the plate deflecting a predetermined distance to lock the portion of the object to the receiver.

17. A transportation vehicle having the locking device of claim 1.
